(19) United States
(12) Patent Application Publication
(10) Pub. No.: US 2008/0282993 A1
(43) Pub. Date: Nov. 20, 2008

(54) ANIMAL TRAINING DEVICE AND METHOD

(75) Inventor: Jeffrey Sylvester Hoehn, Canton, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: CANINE TUTOR, INC., Canton, GA (US)

(21) Appl. No.: 12/121,929

(22) Filed: May 16, 2008

Related U.S. Application Data
(60) Provisional application No. 60/938,833, filed on May 18, 2007.

(51) Int. Cl. A01K 15/02

(52) U.S. Cl. 119/712

(57) ABSTRACT

Devices and methods for training a domestic animal to alert a human that the animal needs to urinate or defecate. Embodiments of the training device include a lower component, a rope-like element, and a locking mechanism. The human utilizes an embodiment of the training device, along with treats or rewards, via an operant conditioning training method to teach the animal to notify the human when the animal needs to relieve itself outside.

### CROSS REFERENCE TO RELATED APPLICATION

This application claims the benefit under 35 U.S.C. 119(e) U.S. Provisional Patent Application No. 60/938,833, filed May 18, 2007, and entitled “Improved Method and System for House Training a Canine,” which is incorporated herein by reference in its entirety.

### FIELD OF THE INVENTION

Embodiments of the present invention relate generally to devices and methods for training domestic animals, and more particularly, to devices and methods for training a dog to notify a human that the dog needs to go outside to urinate and/or defecate.

### BACKGROUND OF THE INVENTION

Many pet owners become frustrated when attempting to teach their dogs to go outside to relieve themselves (i.e. urinate and/or defecate). It may take a young dog several months to learn that it needs to relieve itself outside of the home, and some dogs simply never learn. Even when a dog does learn that it is supposed to relieve itself outside, it will often still have accidents or relieve itself inside if the owner fails to take the dog outside regularly enough, or if the dog has to relieve itself unexpectedly. Accordingly, some training methods and/or devices have been developed in an attempt to teach dogs and other domestic animals not only to relieve themselves outside of the home, but also to alert the animals' owners when the animals need to do so.

Most known training methods for teaching a domestic animal to alert its owner that it needs to relieve itself utilize classical conditioning techniques. Classical conditioning is a form of associative learning based on stimulus-response relationships. A stimulus-may be an object or situation that elicits a response, such as a bright light causing an eye to blink. According to classical conditioning, learning occurs when a new stimulus begins to elicit behavior similar to a behavior produced by an old stimulus.

Studies into classical conditioning began in the early 1900s by Russian physiologist Ivan Pavlov. During his research on the physiology of digestion in dogs, Pavlov noticed that rather than simply salivating in the presence of meat powder (an innate response to food that Pavlov termed an “unconditioned response”), the dogs began to salivate in the presence of the lab technician that normally fed the animals. From this observation, Pavlov predicted that, if a particular stimulus in the dog's surroundings were present when the dog was presented with the meat powder, then the stimulus would become associated with food and cause salivation on its own.

In Pavlov's famous experiments, he trained-dogs to salivate in response to two stimuli—noise or light, and food or a sour solution. The “unconditional stimuli” were the food or sour solution because these elicited the unconditioned response of salivation. The “conditional stimuli” were the noise or light that were repeatedly paired with the unconditional stimuli. Over time, the animals would associate the conditional stimuli with the unconditional stimuli, and would begin to salivate at noise or light alone (without food or the sour solution). Pavlov termed this learned association a “conditioned response”. Generally, unconditional stimuli enable a subject to learn a basic behavior while at the same time reinforcing the learned behavior. Had there been no unconditional stimuli in Pavlov's experiments, he could not have taught the dogs to salivate in the presence of noise or light.

As mentioned, known techniques for training an animal to alert its owner that it needs to relieve itself traditionally employ classical conditioning. For example, one technique uses a strap of sleigh bells attached to the inside of an exterior door of a home. An owner will attempt to teach a dog to ring the bells when it needs to go outside to relieve itself. The owner will start by ringing the bells and then immediately taking the dog outside. The hope is that, over time, the dog will associate ringing the bells with going outside, and will learn that it needs to ring the bells when it needs to relieve itself. However, as mentioned above, with classical conditioning, learning occurs when a new stimulus begins to elicit behavior similar to that produced by an old stimulus. With this traditional training technique, both the stimulus (ringing the bells) and the behavior (going outside) are new to the animal, so there is no unconditioned response for the animal to associate with a new conditioned response. Over time, the dog may learn that when its owner rings a bell, the dog then goes outside. However, the dog has not learned to ring the bells itself, nor has it learned that ringing the bells is correlated to actually relieving itself.

Additionally, under a traditional method, many dogs may be afraid of the noise of the bells, and thus the ringing bell will simply condition the dog to be afraid of the bells, the door, or even going outside in general. Further, if the dog does not enjoy going outside to begin with, then the animal may associate the ringing bells with the negative response of going outside, and thus will never ring the bells on it own. Also, for a dog to learn using the classical technique, the owner must repeat the procedure hundreds of times before the dog may realize that a ringing bell equals going outside to relieve itself, and some dogs may never learn. Even for the dogs that do associate the ringing bell with going outside to relieve themselves, many of these dogs will never learn to ring the bells on their own.

Not only is the classical training method itself ineffective, but the bells used within the method are problematic as well. As mentioned earlier, a bell or loud ringing noise can often frighten an animal. Also, many animals are scared of or adverse to touching bells and other metallic objects in general, thus further preventing the animal from voluntarily hitting a bell to alert an owner that the animal needs to relieve itself. Additionally, even if the animal does learn to paw at the bells to signal that it needs to go outside to relieve itself, many bells are not loud enough to be heard throughout an entire home, or the animal may not be able to ring the bells effectively.

As opposed to classical conditioning, operant conditioning uses consequences to modify the form and occurrence of behavior. Operant conditioning deals with the modification of voluntary behavior. Operant behavior “operates” on the environment and is maintained by its consequences, while classical conditioning deals with the conditioning of respondent behaviors which are elicited by antecedent conditions. Essentially, the theory behind operant conditioning is that one learns to perform a particular behavior as a result of knowing what will happen after the behavior is performed. For example, a dog may learn to beg for food if the begging is usually successful. There is no single stimulus that elicits the begging behavior, but instead it occurs because the dog knows that the action may result in receiving food or a treat.

During the 1930s, American psychologist and behaviorist Burrhus F. Skinner performed several important experiments related to operant conditioning. Using what is now termed a “Skinner Box”, Skinner used operant conditioning to train rats to press levers to receive food. In the experiments, a hungry rat would be placed in a box containing a lever attached to concealed food. Initially, the rat would aimlessly wander around the box and investigate its surroundings. Eventually, it would accidentally press the lever thereby releasing food into the box. At first, the rats would not show any signs of associating the lever with the food, but over time the rats would begin to press the lever more often. The response of a food reward reinforced the rat's behavior of pressing the lever, and eventually the rats would spend the majority of their time pressing the lever to receive food. The rats in the Skinner Box are a classic example of operant behavior—if the behavior is rewarded, then it will occur more frequently.

Operant conditioning is generally considered a more effective method of training animals because the animals shape their behavior towards certain goals. Also, operant conditioning has been shown to teach animals in a quicker and more efficient manner than classical conditioning, resulting in more consistent overall behavior.

Therefore, there is a long felt but unresolved need in the art for a training technique that uses operant conditioning to quickly and effectively teach a domestic animal to relieve itself outside, and to alert a human when the animal needs to do so. Further, there is a need for a training device that will not scare of frighten the animal, will effectively notify the animal's owner, and will also be easy for the animal to use.

### BRIEF SUMMARY OF THE INVENTION

Briefly described, and according to one embodiment the present invention is directed towards a method for training a domestic animal to alert a human that the domestic animal needs to urinate or defecate. The method comprises the step of encouraging the animal to paw at a training device held by a human's hand, wherein the hand also holds one of a plurality of treats. The method further includes the step of teaching the domestic animal to paw at the training device while the training device is removably affixed to a rigid surface. Next, the animal is provided one of the plurality of treats while the animal is outside of the human's home after the animal paws at the training device while the device is removably affixed to the rigid surface. Finally, the animal is provided another one of the plurality of treats only after the animal paws at the training device removably affixed to the rigid surface and subsequently urinates or defecates outside of the human's home.

According to one aspect, the method further comprises the step of enticing the domestic animal to paw at the human's hand before encouraging the animal to paw at the training device held by the human's hand, wherein the hand is making a first shape and clasping one of the plurality of treats therein. According to one aspect, the step of enticing the domestic animal to paw at the human's hand further comprises the steps of enclosing one of the plurality of treats in the human's hand, encouraging the animal to paw at the human's hand via verbal commands, hand movements, or a combination thereof, and upon the animal pawing at the human's hand, releasing one of the plurality of treats onto the ground for the animal.

According to another aspect, the step of encouraging the domestic animal to paw at the training device held by the human's hand further comprises the steps of holding both the training device and one of the plurality of treats in the human's hand, encouraging the animal to paw at the training device via verbal commands, hand movements, or a combination thereof, and upon the animal pawing at the training device, releasing the one of the plurality of treats onto the ground for the animal. In one aspect, the training device is held by the human at varying heights relative to the ground such that the domestic animal learns to paw at the training device at the varying heights.

According to an additional aspect, the step of teaching the domestic animal to paw at the training device while the training device is removably affixed to a rigid surface further comprises the steps of removably affixing the training device to the rigid surface, wherein the training device comprises a lower component positioned approximately chest-high to the domestic animal, and enclosing one of the plurality of treats in the human's hand and positioning the human's hand between the rigid surface and the lower component of the training device. Further, the human then encourages the animal to paw at the lower component via verbal commands, hand movements, or a combination thereof, and upon the animal pawing at the lower component, the human releases one of the plurality of treats onto the ground for the animal. In one aspect, the human moves his or her hand to varying distances away from the training device, and upon the animal pawing at the lower component of the training device, the human tosses one of the plurality of treats onto the ground towards the animal.

According to yet another aspect, the step of providing one of the plurality of treats to the domestic animal outside of the human's home further comprises the steps of placing one of the plurality of treats on the ground outside of the human's home, encouraging the animal to paw at the training device via verbal commands, hand movements, or a combination thereof, and upon the animal pawing at the training device, taking the animal outside of the human's home and allowing the animal to find one of the plurality of treats placed on the ground.

According to a further aspect, the method comprises the steps of providing half of one of the plurality of treats to the domestic animal outside of the human's home after the animal paws at the training device while the device is removably affixed to the rigid surface, and providing another half of one of the plurality of treats to the animal after the animal urinates or defecates outside.

According to still another aspect, the step of providing one of the plurality of treats to the domestic animal only after the animal paws at me training device removably affixed to the rigid surface and subsequently urinates or defecates outside of the human's home further comprises the steps of encouraging the animal to paw at the training device via verbal commands, hand movements, or a combination thereof, upon the animal pawing at the training device, taking the animal outside of the human's home and allowing the animal to urinate or defecate, and providing one of the plurality of treats to the animal only after the animal urinates or defecates.

According to yet a further aspect, the domestic animal is a canine. In one aspect, the plurality of treats are food products.

According to still another aspect, the rigid surface is a door that provides an exit from the human's home. In one aspect, the training device is removably affixed to a door knob attached to the door.

According to another embodiment, the present invention is directed towards an animal training device for teaching a domestic animal to alert a human that the domestic animal needs to urinate or defecate. The training device includes a lower component for being pawed by the domestic animal and a rope-like element attached to the lower component, wherein the rope-like element is adapted for being removably affixed to a rigid surface. The training device further includes a locking mechanism for adjusting the height of the lower component relative to the ground and locking the lower component in place.

According to one aspect, the lower component comprises a rubber ball. In another aspect, the rubber ball includes raised ridges on its outer surface.

According to a further aspect, the rope-like element comprises a cotton rope. In one aspect, the locking mechanism comprises a cord lock.

These and other embodiments and aspects of the present invention will become apparent from the following description of the preferred embodiment taken in conjunction with the following drawings, although variations and modifications therein may be affected without departing from the spirit and scope of the hovel concepts of the disclosure.

### BRIEF DESCRIPTION OF THE DRAWINGS

The accompanying drawings illustrate one or more embodiments of the invention and, together with the written description, serve to explain the principles of the invention. Wherever possible the same reference numbers are used throughout the drawings to refer to the same or like elements of an embodiment, and wherein:

FIG. 1 is a perspective view of a canine pawing at a training device attached to a door to alert its owner that it needs to go outside and relieve itself according to an embodiment of the present invention.

FIG. 2A is a front cross-sectional view of an embodiment of the training device while the training device is removably affixed to a doorknob.

FIG. 2B shows a perspective view of an embodiment of the ball with raised ridges on its surface.

FIG. 3 is a flow chart depicting the overall steps involved in a method for training an animal to notify its owner when it needs to go outside to relieve itself according to an embodiment of the present invention.

FIG. 4 illustrates a flow chart showing the steps involved in teaching an animal to paw at its owner's hand according to an embodiment of the present invention.

FIG. 5 is a flow chart demonstrating the steps involved in teaching an animal to paw at a ball in its owner's hand according to an embodiment of the present invention.

FIG. 6 shows steps related to teaching an animal to paw at a training device hanging from a door according to an embodiment of the present invention.

FIG. 7 is a flow chart showing the steps involved in teaching an animal to paw at a training device to receive a reward outside of the home according to an embodiment of the present invention.

FIG. 8 illustrates a flow chart depicting the steps involved in teaching an animal that it will receive half of a reward when the animal relieves itself outside according to an embodiment of the present invention.

FIG. 9 is a flow chart showing an embodiment of the steps utilized to train an animal that it will receive a reward only when it paws at an embodiment of a training device and subsequently relieves itself outside.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in me description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatuses, systems, and methods of the invention and how to make and use them. For convenience, certain terms may be highlighted, for example using italics and/or quotation marks. The use of highlighting has no influence on the scope and meaning of a term; the scope and meaning of a term is the/same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

In general, embodiments of the present invention provide novel devices and methods for training a domestic animal to alert its owner when it needs to urinate and/or defecate. For purposes of this application, the phrase “relieve itself” will refer to the domestic animal urinating and/or defecating. As described earlier, embodiments of the present invention employ operant conditioning. There are four main consequences associated with operative learning or conditioning, which are: positive reinforcement, negative reinforcement, punishment, and omission training. Positive reinforcement occurs when a behavior is followed by a favorable stimulus that increases the frequency of that behavior (for example, a rat pressing a lever to receive food). Negative reinforcement occurs when a behavior is followed by the removal of an aversive stimulus, again increasing the frequency of the behavior (for example, continuously sounding a loud noise inside a rat's cage until the rat presses a lever, whereby the noise is removed). Punishment occurs when a behavior is followed by an aversive stimulus resulting in a decrease of that behavior (for example, introducing a shock when a rat presses a lever). Omission training occurs when a behavior is followed by the removal of a favorable stimulus resulting in a decrease in that behavior (for example, taking away a child's toy following an undesired behavior).

Preferably, embodiments of the present invention incorporate the positive reinforcement type of operant conditioning. However, other types of operant conditioning may be used without departing from the spirit and scope of the present invention. Additionally, while embodiments of the present invention may be used with many different kinds of domestic animals, the present application will refer primarily to canines for ease of reference.

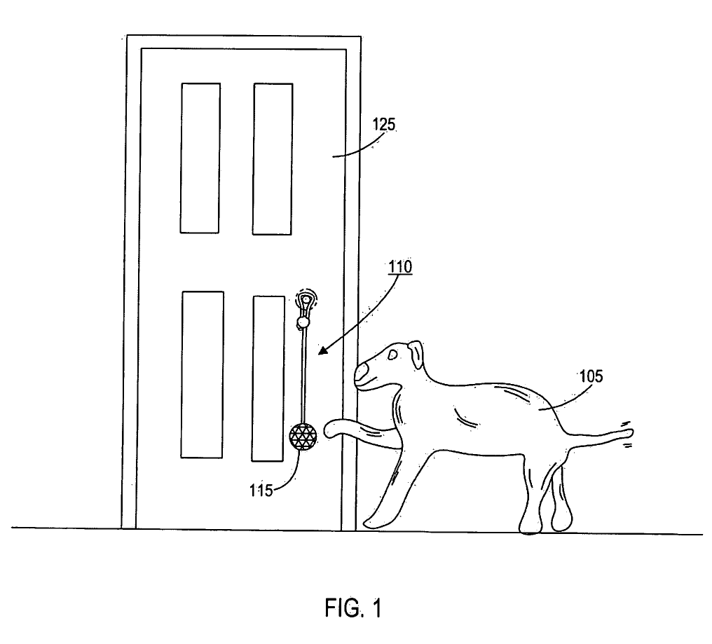

Referring now to the drawings, FIG. 1 illustrates a perspective view of a dog 105 pawing at a training device 110 attached to a door 125 to alert its owner that it needs to go outside and relieve itself according to an embodiment of the present invention. After employing the teaching methods described herein, the dog 105 learns to hit or paw at the ball portion 115 of the training device 110 to create a sound that notifies the dog's owner that it needs to go outside to relieve itself. In this application, the training device 110 itself will first be described, and a method for using the device will be described thereafter.

### Training Device

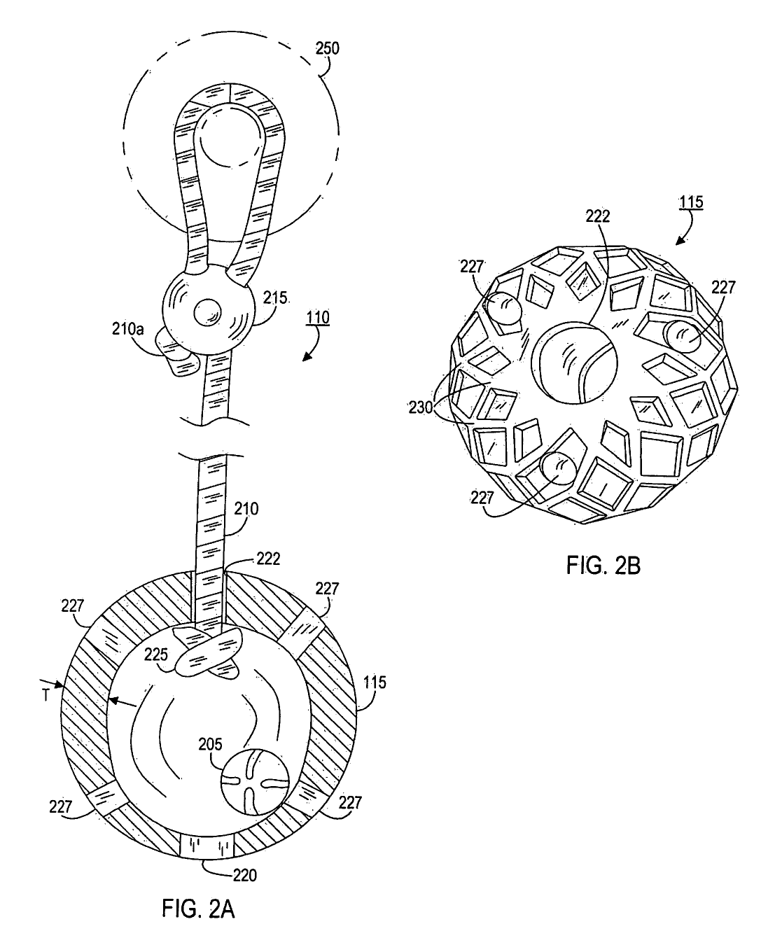

FIG. 2A is a front cross-sectional view of an embodiment of the training device 105. As shown, the training device 110 includes a ball portion 115, a bell 205, a connecting rope 210, and a cord lock 215. The device 110 is shown hanging from a door knob 250 with the cord lock 215 in a tightened, raised position along the connecting rope 210. The cord lock 215 and excess rope 210a should be adjusted, such that the ball 115 hangs at a height approximately chest-high to the particular animal 105 using the device 110 (as shown in FIG. 1) to enable the animal to easily and effectively paw at the device. The excess rope 210a may be tied in a knot or cut so as not to interfere with the dog's use of the device.

The ball portion 115 shown in FIG. 2A preferably has an outer diameter of 2 and 3/16 inches and is preferably made of a heavy rubber material. The ball 115 preferably has a tapering thickness T that is about ½ inch at the top of the ball close to the connecting rope 210, and tapers to about ¼ inch at the bottom of the ball near lower hole 220. The tapering thickness T gives the ball 115 added durability around the top and middle areas of the ball where it is most likely to be struck by an animal 105, while creating more room for the bell 205 to move and ring in the lower portions of the ball. The lower hole 220 preferably has a diameter of ½ inch, whereas the upper hole 222 has a diameter of 3/16 inch. Generally, it is preferable that the lower hole 220 have a diameter greater than that of the upper hole 222 so that when the training device 110 is initially constructed, the connecting rope 210 may be fed through both holes 222, 220, tied into holding knot 225, and pulled back inside the ball 115 through lower hole 220. Additionally, the larger size of lower hole 220, as well as sound holes 227, enable the sound created by the bell 205 to be heard more clearly and loudly. However, as will be understood, the diameter of lower hole 220 should be less than the diameter of the bell 205 to ensure the bell does not fall through the lower hole and escape the ball portion 115 of the training device 110. As will be understood by one of skill in the art, the above-described dimensions of the ball portion 115 are for demonstrative purposes only, and such dimensions may be varied depending on the size of the animal 105 and the preferences of the user. Additionally, as will also be understood, while a ball shape is preferable, the ball portion 115 may be any number of shapes, including a cube, pyramid, egg shape, or the like.

Further, the bell 205 is preferably a ¾ inch diameter circular bell commercially available from Nantong Sanxing Gym Equipment Co., Ltd., having an office and place of business at No. 76 Jiefang Road (M), Baochang Town, Haimen City, JiangSu, China. However, as will be understood by one having ordinary skill in the art, the bell 205 may comprise other makes and/or models of bells, or may incorporate other similar noise devices. Further, as noted previously, bells or metallic objects may often scare domestic animals. However, because the bell 205 used in embodiments of the present invention is contained within a rubber ball 115, the dog 105 does not directly contact the metal bell, and thus is not frightened by it.

As mentioned, the ball 115 is preferably made of a heavy rubber material. This rubber should be soft enough so that the dog 105 enjoys pawing at the ball 115, but dense enough to create sufficient noise when the ball is bounced off the door 125. While the bell 205 inside the ball 115 serves as one form of notification to an owner that a dog 105 needs to relieve itself, the bouncing of the dense rubber ball 115 against the door 125 creates added notification. Accordingly, the ball 115 is of sufficient weight and size so as to make a banging noise when hit against a door 125, but at the same time is small and light enough to be used by any sized canine. Thus, a ball 115 made from a heavy rubber material and manufactured according to the preferred dimensions described herein creates a training device 110 that is both effective and easy for the animal 105 to use. Also, the rubber used with embodiments of the ball 115 should be sufficiently durable so as to withstand repeated pawing or hitting by the dog 105.

FIG. 2B shows a perspective view of an embodiment of the ball 115 with raised ridges or grooves 230 on the surface of the ball to create added friction so that the dog 105 may easily hit and move the ball. Although a diamond pattern of grooves 230 is shown in FIG. 2B, one having skill in the art, will understand that any raised surface will create added friction, such as parallel lines, bumps, and the like. Also, the rubber used to manufacture the ball 115 preferably has a rough or coarse surface, similar to fine grit sandpaper, to create even more friction between the dog's paw and the ball. Generally, it may be difficult for a smaller dog 105 to effectively swing the ball 115 if the ball has a smooth surface. Thus, a ball with a rough outer surface and raised ridges 230 is preferred for most dogs. However, as one of skill will understand, neither grooves 230 or a rough surface are required for all embodiments of the present invention.

Returning to FIG. 2A, the upper hole 222 of the ball portion 115 is designed to accommodate a connecting rope 210 to hold the ball and attach it to a door knob 250. As shown, the ball 115 is held in place by holding knot 225. While attaching the connecting rope 210 to the ball 115 via an upper hole 222 and a holding knot 225 is preferred, it will be understood that other attachment mechanisms are possible, such as a high-strength adhesive or the like. Additionally, the lower hole 220, as well as sound holes 227, are designed primarily to enable the sound from the bell 205 to escape the ball 115 and be heard throughout a dog owner's home. However, as mentioned, these holes 220, 227 are small enough such that the bell will not be knocked out of the ball 115 when hit by a canine 105.

The connecting rope 210 is preferably made of cotton or similar soft material. Cotton is strong and durable, but yet flexible and soft to the dog's 105 touch. More abrasive materials, such as metal wiring of plastic netting, can become stuck between an animal's 105 toes or may injure the animal. Additionally, the preferred diameter of the rope 210 is about 3/16 inch. A rope that is approximately 3/16 inch in diameter will be flexible enough to swing and be tied in knots, but durable enough to withstand repeated hitting by the animal 105. Also, a rope of 3/16 inch fits ideally within the preferred upper hole 222 diameter described above, but leaves sufficient room when knotted inside the ball 115 as holding knot 225 for the bell to rattle against the inside surfaces of the ball. Moreover, the rope 210 should be of sufficient length so as to wrap around a door knob 250 or other holding mechanism and to lower the ball 115 to an appropriate height for the particular animal 105. Preferably, the length of the rope should be at least 39 inches.

Still referring to FIG. 2A, the cord lock 215 shown in the figure is a two-hole ball cord lock comprising two 3/16 inch diameter holes to receive the connecting rope 210. The cord lock 215 is commercially available from Nantong Sanxing Gym Equipment Co., Ltd., having an office and place of business at No. 76 Jiefang Road (M), Baochang Town, Haimen City, JiangSu, China. However, as one having ordinary skill in the art will appreciate, other types, makes and models of cord locks and adjustable locks may be used within embodiments of the present invention.

Additionally, while the training device 110 is described in conjunction with use on a door 125 having a door knob 250, those of skill in the art will understand that the device may be hung from a hook against a wall, attached to a kitchen counter, or used in any other similar way so long as an animal 105 can effectively hit the device to alert its owner that it needs to go outside to relieve itself.

### Training Method

As one having ordinary skill in the art will understand, while embodiments of the method described below preferably incorporate and use an embodiment of the training device 110 described above, the methods may also use similar devices or apparatuses to achieve the desired goal of training a domestic animal to alert its owner that it needs to relieve itself. Thus, the methods described herein are not limited to the use of the specific embodiments of the training device 110 detailed herein. Alternatively, the above-described training device 110 is believed to have novelty on its own, and is not solely limited for use with the currently-described methods.

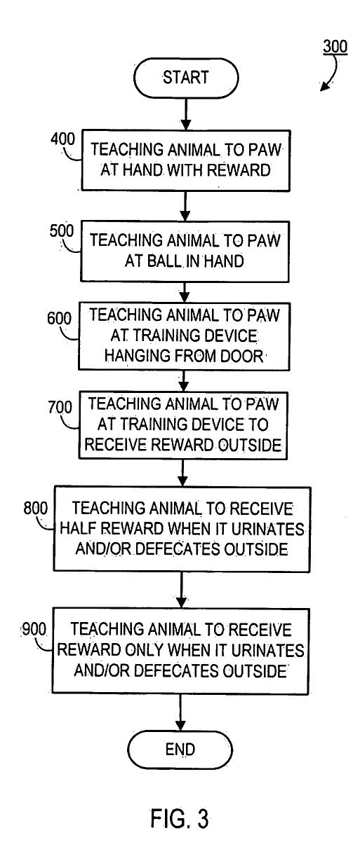

FIG. 3 is a flow chart depicting the overall steps involved in a method 300 for training an animal 105 to notify its owner when it needs to go outside to relieve itself according to an embodiment of the present invention. As shown, the primary steps involved in the method 300 include teaching the animal 105 to paw at its owner's hand while a reward or treat is clasped in the hand (steps 400), teaching the animal to paw at the owner's hand while a reward and a ball 115 is clasped in the hand (steps 500), and teaching the animal to paw at an embodiment of the training device 110 while the device is hanging from a door (steps 600). Additionally, the overall steps illustrated in the embodiment of the method 300 shown in FIG. 3 further include teaching an animal 105 to paw at an embodiment of the training device 110 to receive a reward outside of the owner's home (steps 700), teaching the animal to receive half of a reward when it urinates and/or defecates outside (steps 800), and teaching the animal to receive an entire reward only when it urinates and/or defecates outside (steps 900). When all six of these overall processes 400, 500, 600, 700, 800, 900 are completed, an animal 105 will be sufficiently trained to notify its owner when it needs to relieve itself.

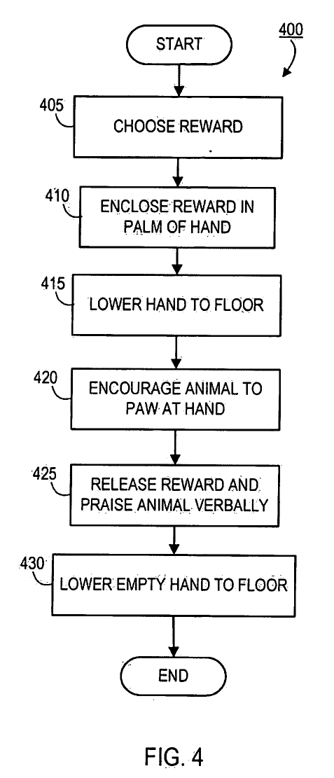

FIG. 4 illustrates a flow chart showing the steps involved in teaching an animal 105 to paw at its owner's hand (process 400) according to an embodiment of the present invention. At step 405, the owner should choose a reward or treat that the dog 105 typically does not receive. The reward should preferably be a treat with a strong smell and taste so that the animal 105 can locate the treat more effectively and will be adequately enticed by the treat. Non-limiting examples of treats or rewards that may be used within embodiments of the present invention include, chicken strips, bacon strips, beef strips, animal pepperoni, liver, and the like. At step 410, the owner should enclose the reward in the palm of his or her hand and close the hand lightly around the reward. The owner should then lower his or her hand towards the floor (step 415) and encourage the dog 105 to paw at the hand containing the treat (step 420). In some instances, the owner may need to let the animal 105 have one or two treats to show the animal what is contained in the hand. Also, the owner should verbally encourage the animal 105 to attempt to get the reward by saying “get it,” or some other similar phrase. Further, the owner may have to jerk the hand in a playful motion to encourage some animals 105 to paw at the hand. Once the dog 105 begins pawing at the owner's hand, the owner should praise the dog verbally and let the treat roll out of the hand onto the floor (step 425). These steps should preferably be repeated several times in a row until the dog understands that it needs to paw at the hand in order to receive the reward.

Once the dog 105 understands that if needs to paw at the owner's hand to receive a reward, it will often begin to paw at the hand as soon as the hand moves towards the ground. At this stage, the owner should lower an empty hand towards the floor (step 430) to test the dog's understanding. If the dog 105 still paws at the empty hand, the dog is ready to move on to steps 500. Alternatively, if the dog fails to paw at the empty hand and simply waits for the treat, the owner should repeat steps 405-425 before moving on. However, even if the dog 105 does not paw at the owner's empty hand, if the dog emphatically paws at the hand with a reward enclosed, the dog is likely ready to move on to steps 500. Generally, it should only take the dog 105 a few minutes to comprehend the process involved in steps 400.

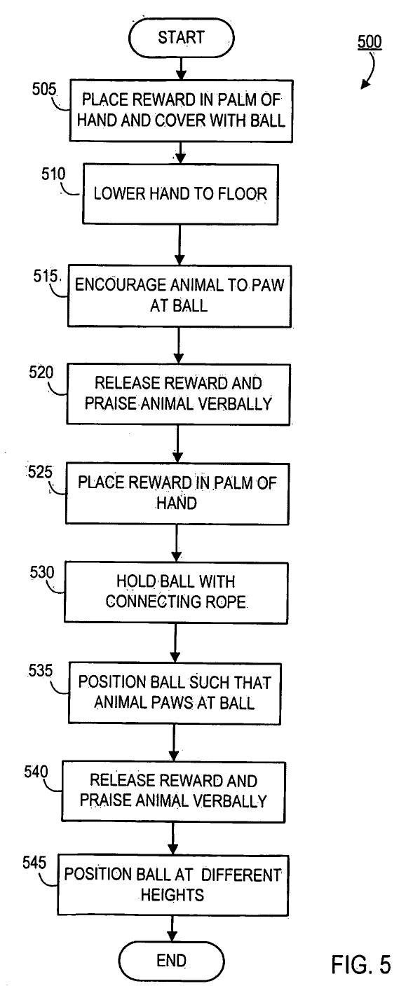

FIG. 5 is a flow chart demonstrating the steps involved in teaching an animal 105 to paw at a ball 115 in an owner's hand (process 500) according to an embodiment of the present invention. At step 505, the owner should enclose a reward or treat in the palm of his of her hand as in step 410, and then cover the reward with a ball 115. Preferably, the treat should be pinned against the owner's palm by pulling the ball 115 against the palm with his or her fingers. At steps 510, 515 the owner should lower his or her hand towards the floor and encourage the animal 105 to paw at the ball 115 just as the owner encouraged the animal to paw at his or her hand in step 420. Again, some dogs 105 may require the owner to move the ball 115 around and essentially make a game of the training. Once the animal 105 paws at the ball 115, the owner should let the treat roll but onto the ground and should praise the animal verbally (step 520). During step 520, the owner should move the ball 115 slightly and let the reward fall to the ground as if pawing at the ball produced the treat.

After the animal 105 becomes comfortable with pawing at the ball 115 in the owner's hand to receive a reward, the owner should then place the reward in the palm of his or her hand (step 525) and hold the ball 115 by the connecting rope 210 at the point where the connecting rope enters the upper hole 222 (step 530). Preferably, the owner should pinch the connecting rope 210 between his or her index finger and thumb and dangle the ball 115 in front of his or her hand while holding the reward in his or her palm. The owner should then position the ball 115 such that the dog paws at the ball while it is dangling from the owner's hand (step 535). Once the dog 105 paws at the ball 115, the owner should release the treat and praises the dog verbally (step 540). Next, the owner should repeat steps 525-540 while positioning the ball 115 at varying heights from the floor (step 545). Preferably, the animal 105 should be able to paw at the ball 115 when the ball is chest-high to the animal. Preferably, the steps involved with process 500 should be repeated several times before moving on to process 600. Typically, it should only take an animal 105 a few minutes to understand the process involved with steps 500. In some instances, an animal 105 may become full or tired after completing steps 500, in which case the dog should be allowed to rest before engaging in steps 600.

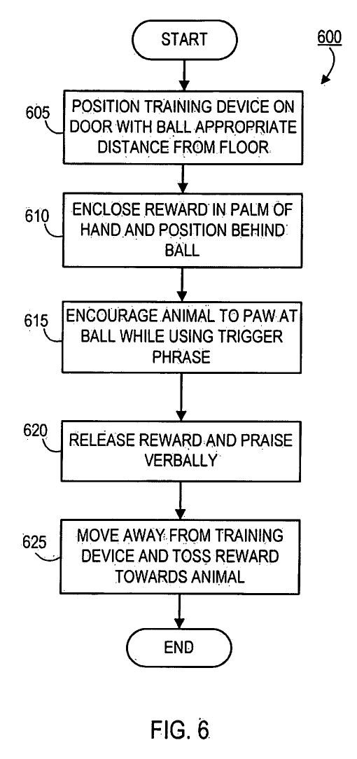

Referring now to FIG. 6, the steps 600 related to teaching an animal 105 to paw at a training device 110 hanging from a door 125 are shown according to an embodiment of the present invention. At step 605, the owner should position the training device 110 on the door knob 250 of a door 125 such that the ball 115 is an adequate height from the floor to enable the animal 105 to successfully paw at the ball. Preferably, the device 110 should be positioned such that the ball 115 is chest-high to the particular animal. However, different animals 105 may prefer different heights, so the owner may have to try different heights to determine the specific height that enables the particular animal to use the device 110 most effectively. Once an appropriate height is determined, the owner should tighten the connecting rope 210 around the door knob 250 with the cord lock 215. As one having ordinary skill in the art will understand, while embodiments of the present invention are described as using the training device 110 with a conventional door 125 and door knob 250, the device may be positioned against any wall or hard surface in an owner's home as long as the animal realizes that it should paw or hit the ball to notify the owner that it needs to relieve itself.

After the training device 110 has been secured to the door knob 250, the owner should enclose a reward in the palm of his or her hand and position his or her hand behind the hanging ball 115 (step 610). The owner should next encourage the animal 105 to paw at the ball 115 by using a trigger phrase, such as “want to go outside?”, or something similar (step 615). When the dog 105 responds and hits or paws at the ball 115, the owner should drop the treat to the ground and praises the dog verbally (step 620). It should appear to the animal 105 that the reward has fallen from the ball 115 caused by the animal's pawing. After repeating steps 605-620 a few times with his or her hand behind the ball 115, the owner should begin moving his or her hand slowly away from the ball, such that when the animal 105 paws at the ball the owner drops or tosses the reward on the ground below the training device 110 from some distance away from the device (step 625). The goal of step 625 is to train the animal 105 to believe it will receive a reward on the ground when it hits the ball 110, and that the reward has nothing to do with the positioning or proximity of the owner. The animal 105 should believe that the receipt of a treat is entirely based on its interaction with the training device 110.

In some instances, the dog 105 may become confused when the owner begins moving further and further from the ball 115. If this happens, the owner should draw the animal's attention to the ball 115 by shaking it and repeating the trigger phrase, and then dropping a treat on the ground when the animal hits the ball. The owner may need to repeat the initial steps 605-620 a few more times before the owner can begin moving away from the device to deliver the reward. Generally, most animals 105 will learn the process behind steps 600 in under an hour. Once the animal fully understands steps 600, the owner can move on to steps 700.

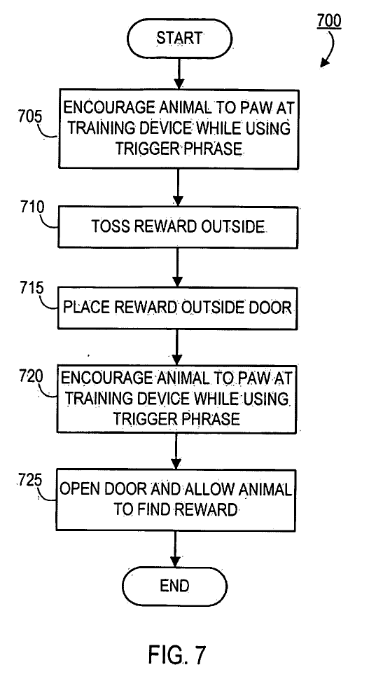

FIG. 7 is a flow chart showing the steps involved in teaching an animal 105 to paw at a training device 110 to receive a reward outside of the home (process 700) according to an embodiment of the present invention. At step 705, the owner should bring the dog 105 to the door 125 and encourage the dog to paw at the training device 110 while using the trigger phrase. Once the dog 105 hits the ball 115, the owner should open the door 125 and throw the reward outside onto the ground (step 710). Steps 705-710 should be repeated a few times until the animal 105 understands that it will receive a reward outside from the owner when it paws at the ball 115. After the dog 105 learns to look for a reward outside when it hits the ball 115, the owner should modify the training according to step 715. The owner should place a treat or reward outside of the door 125 when the animal 105 is not present, and then close the door (step 715). The owner should then get the animal and encourage the animal to paw at the training device 110 while repeating the trigger phrase (step 720). Once the animal 105 paws at the device 110, the owner should open the door and allow the animal to find the reward on the ground outside (step 725). Steps 715-725 should be repeated several times until the dog expects a reward to be outside when the dog hits the ball 115.

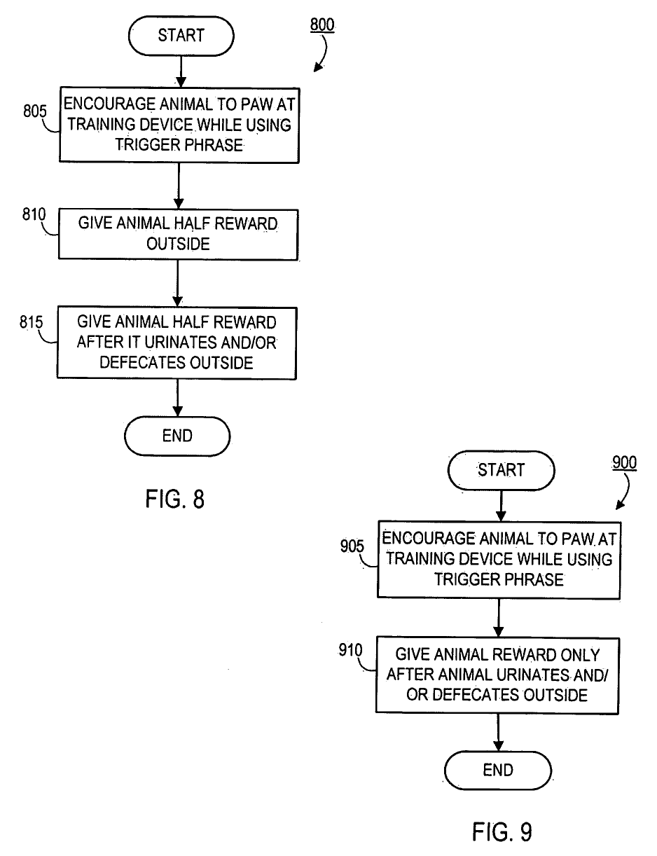

Referring now to FIG. 8, a flow chart is shown depicting the steps involved in teaching an animal 105 that it will receive half of a treat when the animal relieves itself outside according to an embodiment of the present invention. At step 805, the owner should encourage the animal 105 to paw at the training device 110 while using a trigger phrase. After the animal 105 hits the device 110, the owner should reward the animal with half of a treat on the ground outside (step 810). Next, the owner should walk the dog 105 in a conventional manner so that the animal may relieve itself outside. Once the dog 105 does in fact relieve itself, the owner should reward the dog with the second half of the treat (step 815). If the dog does not relieve itself, then the owner should not supply the animal with any treat or reward other than the half reward the animal received when it first emerged outside. Steps 805-815 preferably should be repeated several times over an extended period of time. Ultimately, the animal 105 will realize that it receives an additional treat when it relieves itself outside.

FIG. 9 is a flow chart illustrating an embodiment of the steps utilized to train an animal 105 that it will receive a reward only when it paws at an embodiment of the training device 110 and subsequently relieves itself outside (process 900). At step 905, the owner should encourage the animal 105 to hit the training device 110 while using the trigger phrase. At this stage, the owner should not give the animal any reward or treat for simply pawing the ball 115. Once the animal paws the ball 115, the owner should take the dog outside and walk it in a conventional manner. If the dog 105 relieves itself, the owner should immediately give the animal a reward or treat (step 910). If the animal does not relieve itself, then it should receive no treat. Just as with process 800, steps 900 will require several repetitions. Over time, the animal 105 will realize that it only receives a treat when it hits the ball 115 and then relieves itself outside.

Eventually, as the dog learns the above-described steps and processes, the use of treats and reward can be minimized, or altogether eliminated. Once the animal 105 has completed all of the steps in the above-described embodiment; of the training method 300, the dog will be sufficiently trained to paw at or hit the training device 110 when the animal needs to relieve itself. In some circumstances, the use of rewards when the dog relieves itself may need to be, continued intermittently so that the dog does not forget its training. Also, some steps in the method 300 may need to be repeated depending on the intelligence level of the particular animal 105. However, proper use of an embodiment of the training device 110 and method 300 described herein will result in a trained dog that alerts its owner(s) when it needs to relieve itself.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for training a domestic animal to alert a human that the domestic animal needs to urinate of defecate; comprising the steps of:
encouraging the domestic animal to paw at a training device held by a hand of the human, wherein the hand also holds one of a plurality of treats;
teaching the domestic animal to paw at the training device while the training device is removably affixed to a rigid surface;
providing one of the plurality of treats to the domestic animal outside of the human's home after the animal paws at the training device while the device is removably affixed to the rigid surface; and
providing one of the plurality of treats to the domestic animal only after the animal paws at the training device removably affixed to the rigid surface and subsequently urinates or defecates outside of the human's home.

2. The method of claim 1, further comprising the step of enticing the domestic animal to paw at the human's hand before encouraging the animal to paw at the training device held by the human's hand, wherein the hand is making a first shape and clasping one of the plurality of treats therein.

3. The method of claim 2, wherein the step of enticing the domestic animal to paw at the human's hand further comprises the steps of:
enclosing one of the plurality of treats in the human's hand;
encouraging the animal to paw at the human's hand via verbal commands, hand movements, or a combination thereof; and
upon the animal pawing at the human's hand, releasing the one of the plurality of treats onto the ground for the animal.

4. The method of claim 1, wherein the step of encouraging the domestic animal to paw at the training device held by the human's hand further comprises the steps of:
holding both the training device and one of the plurality of treats in the human's hand;
encouraging the animal to paw at the training device via verbal commands, hand movements, or a combination thereof; and
upon the animal pawing at the training device, releasing the one of the plurality of treats onto the ground for the animal.

5. The method of claim 4, further comprising the step of positioning the training device held by the human at varying heights relative to the ground such that the domestic animal learns to paw at the training device at the varying heights.

6. The method of claim 1, wherein the step of teaching the domestic animal to paw at the training device while the training device is removably affixed to a rigid surface further comprises the steps of:
removably affixing the training device to the rigid surface, wherein the training device comprises a lower component positioned approximately chest-high to the domestic animal;
enclosing one of the plurality of treats in the human's hand and positioning the human's hand between the rigid surface and the lower component of the training device;
encouraging the animal to paw at the lower component via verbal commands, hand movements, or a combination thereof; and
upon the animal pawing at the lower component, releasing the one of the plurality of treats onto the ground for the animal.

7. The method of claim 6, further comprising the steps of:
moving the human's hand to varying distances away from the training device; and
upon the animal pawing at the lower component of the training device, tossing the one of the plurality of treats onto the ground towards the animal.

8. The method of claim 1, wherein the step of providing one of the plurality of treats to the domestic animal outside of the human's home further comprises the steps of:
placing the one of the plurality of treats on the ground outside of the human's home;
encouraging the animal to paw at the training device via verbal commands, hand movements, or a combination thereof; and
upon the animal pawing at the training device, taking the animal outside of the human's home and allowing the animal to find the one of the plurality of treats placed on the ground.

9. The method of claim 1, further comprising the steps of:
providing half of one of the plurality of treats to the domestic animal outside of the human's home after the animal paws at the training device while the device is removably affixed to the rigid surface; and
providing another half of one of the plurality of treats to the animal after the animal urinates or defecates.

10. The method of claim 1, wherein the step of providing one of the plurality of treats to the domestic animal only after the animal paws at the training device removably affixed to the rigid surface and subsequently urinates or defecates outside of the human's home further comprises the steps of:
encouraging the animal to paw at the training device via verbal commands, hand movements, or a combination thereof;
upon the animal pawing at the training device, taking the animal outside of the human's home and allowing the animal to urinate or defecate; and
providing the one of the plurality of treats to the animal only after the animal urinates or defecates.

11. The method of claim 1, wherein the domestic animal is a canine.

12. The method of claim 1, wherein the plurality of treats comprise food products.

13. The method of claim 1, wherein the training device comprises:
a lower component for being pawed by the domestic animal;
a string like element attached to the lower component, wherein the string-like element is removably affixed to the rigid surface; and
a locking mechanism for adjusting the height of the lower component relative to the ground and locking the lower component in place.

14. The method of claim 1, wherein the rigid surface is a door that provides an exit from the human's home.

15. The method of claim 14, wherein the training device is removably affixed to a door knob attached to the door.

16. An animal training device for teaching a domestic animal to alert a human that the domestic animal needs to urinate or defecate, comprising:
a lower component for being pawed by the domestic animal;
a rope-like element attached to the lower component, wherein the rope-like element is adapted for being removably affixed to a rigid surface; and
a locking mechanism for adjusting the height of the lower component relative to the ground and locking the lower component in place.

17. The animal training device of claim 16, wherein the lower component comprises a rubber ball.

18. The animal training device of claim 17, wherein the rubber ball comprises raised ridges on its outer surface.

19. The animal training device of claim 16, wherein the rope-like element comprises a cotton rope.

20. The animal training device of claim 16, wherein the locking mechanism comprises a cord lock.
